(19) United States
(12) Patent Application Publication
(10) Pub. No.: US 2008/0199752 A1
(43) Pub. Date: Aug. 21, 2008

(54) Electrochemical stack with pressed bipolar plate

(75) Inventors: Robin Edward Clarke, Elwood (AU); Sarbjit Singh Giddey, Glen Waverley (AU); Fabio T. Ciacchi, Clayton (AU); Sukhvinder P.S. Badwal, Clayton (AU)

Correspondence Address: LAHIVE & COCKFIELD, LLP, ONE POST OFFICE SQUARE, BOSTON, MA, 02109, US

(73) Assignee: Commonwealth Scientific and Industrial Research Organisation, Campbell (AU)

(21) Appl. No.: 11/708,393

(22) Filed: Feb. 20, 2007

(51) Int. Cl. H01M 8/10

(52) U.S. Cl. 429/30

(57) ABSTRACT

An electrochemical cell having a central active area and a perimeter area, the electrochemical cell including: a membrane electrode assembly (MEA) having a first electrode, a proton exchange membrane, and a second electrode of opposite electrical polarity to the first electrode; a pressed metal interconnect having on a first side a raised portion in electrical contact with the first electrode; the interconnect and the first electrode defining at least one fluid channel between the interconnect and the first electrode in the central active area, such that a fluid conveyed in the fluid channel is in fluid communication with the first electrode; a gasket interposed between the membrane and the interconnect in the perimeter area, such that the fluid is sealed within the fluid channel; and a fluid opening in the gasket allowing fluid communication between the fluid channel and a manifold in the perimeter area.

### FIELD OF THE INVENTION

The present invention relates to polymer electrolyte membrane (PEM) electrochemical cells. The invention has been primarily developed for use as a PEM electrolyser stack having a plurality of electrolyser cells, and will be described herein by particular reference to that application. However, the invention is by no means restricted as such, and has various alternate applications in a broader context.

### BACKGROUND

The predominant design of conventional PEM fuel cells and electrolysers takes the form of a stack of numerous planar cells set one beside the other as in the slices in a loaf of bread. This arrangement places the cells electrically in series, so that the same current flows through all cells and the overall voltage is the total of the individual cell voltages. Each such cell is bordered by a “plate” that serves many simultaneous functions. These include the provision of mechanical support and strength, sealing in the liquids and gases that flow inside each cell and the provision of gas (and liquid) flow paths as well as electrical contact points to the electrode assembly at the core of the cell. Whilst this functionality could conceivably be achieved by a multi-component assembly, there are a number of reasons why it is generally preferable to carry out all these functions with a single component. The performance requirements on this component are stringent. They include high corrosion resistance, low electrical resistivity and gas tightness. For a number of reasons, including corrosion performance, titanium metal is the preferred material. Stainless steel and other metals or alloys, possibly with protective coatings, may also be used. The flow channels are generally machined.

It is further beneficial for design efficiency if the same machined component that forms the positive plate of one cell can simultaneously fulfil the role of negative plate for the next cell in the stack. Thus, the plate is double sided, or “bipolar”, and since it automatically fulfils the additional role of electrically connecting one cell to the next, it is known as a “bipolar interconnect”.

Machined interconnects are usually bipolar and are generally in the range 3 mm to 10 mm thick. This thickness is required to allow flow channels to be machined into each face and for flow ports to be drilled transversely through the plate. These transverse ports allow the flow channels in the active area of each cell to be connected to an external or internal manifold for the passage of water and gases into and out of the cell. The uniform thickness of the plate, both within and outside the active area, allows for simple assembly with co-planar gaskets.

### SUMMARY OF THE INVENTION

It is an object of the present invention to provide an improved electrolyser stack.

In accordance with a first aspect of the present invention, there is provided an electrochemical cell having a central active area and a perimeter area, the electrochemical cell including: a membrane electrode assembly (MEA) having a first electrode, a proton exchange membrane, and a second electrode of opposite electrical polarity to the first electrode; a pressed metal interconnect having on a first side a raised portion in electrical contact with the first electrode; the interconnect and the first electrode defining at least one fluid channel between the interconnect and the first electrode in the central active area, such that a fluid conveyed in the fluid channel is in fluid communication with the first electrode; a gasket interposed between the membrane and the interconnect in the perimeter area, such that the fluid is sealed within the fluid channel; and a fluid opening in the gasket allowing fluid communication between the fluid channel and a manifold in the perimeter area.

Preferably, the electrochemical cell includes a spacer interposed between the membrane and the interconnect in the perimeter area adjacent the fluid opening to define a side of the fluid opening. The proton exchange membrane is preferably a polymer electrolyte membrane (PEM) interposed between the first and second electrodes. Preferably, the first and second electrodes are within the central active area and the polymer electrolyte membrane extends beyond the ends of the first and second electrodes into the perimeter area.

The raised portion preferably includes a plurality of ridges in electrical contact with the first electrode, the ridges defining a plurality of the fluid channels between the interconnect and the first electrode. The ridges are preferably located away from the gasket, thereby defining a header space in fluid communication with each fluid channel and the fluid opening.

The interconnect preferably includes on a second side opposing the first side, a second raised portion that can be in electrical contact with an electrode in a second electrochemical cell. The interconnect preferably includes ridges on the first and second sides, each ridge forming a complementary groove in the opposing side, the ridges on the second side defining the second raised portion.

The interconnect preferably defines with each electrode in electrical contact, at least one respective fluid channel between the interconnect and the respective electrode, such that a respective fluid conveyed in each fluid channel can be in fluid communication with the respective electrode. The interconnect preferably can be in electrical contact with electrodes of opposite electrical polarity, such that the interconnect can be a bipolar interconnect. The interconnect can include in the first side a recess adjacent the fluid opening to increase the size of the fluid opening.

In accordance with a further aspect of the present invention, there is provided an electrochemical cell stack including a plurality of the electrochemical cells described above connected in series, wherein the second raised portion of the interconnect of each electrochemical cell is in electrical contact with the second electrode of the next electrochemical cell.

Preferably, the ridges on the second side of the interconnect of each electrochemical cell are in electrical contact with the second electrode of the next electrochemical cell, one of the first and second sides of each interconnect has one more ridge than the other of the first and second sides of the interconnect, and successive interconnects have the first and second sides reversed, such that successive interconnects are in a back-to-back configuration.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 is a partial sectional view of an electrolysis cell in accordance with an embodiment of the present invention, showing the components of the cell, including a pressed metal bipolar interconnect;

FIG. 2 is a plan view of the pressed metal bipolar interconnect of the electrolysis cell shown in FIG. 1;

FIG. 3 is an end view of the interconnect shown in FIG. 2; and

FIG. 4 is a side view of the interconnect shown in FIG. 2.

### DETAILED DESCRIPTION OF THE PREFERRED AND OTHER EMBODIMENTS

Referring to the figures, the electrolysis cell of the preferred embodiment includes a membrane electrode assembly (MEA) 1 having a first electrode 2, and a second electrode 3 of opposite electrical polarity to the first electrode. The electrolysis cell further includes a pressed metal bipolar interconnect, in the form of a plate 4. The interconnect has on a first side 5 a raised portion, in the form of a plurality of ridges 6, in electrical contact with the first electrode 2. The interconnect 4 and the first electrode 2 define a plurality of fluid channels, in the form of valleys 7, between the interconnect and the first electrode, such that a fluid conveyed in the fluid channels is in fluid communication with the first electrode. A gasket 8 is interposed between a spacer 9 and the interconnect 4 in a perimeter area, such that the fluid is sealed within the fluid channels 7. A fluid opening, in the form of flow port 10, in the gasket 8 allows fluid communication between the fluid channels 7 and a manifold 11 in the perimeter area. A polymer electrolyte membrane 12 is interposed between the first and second electrodes 2 and 3 to form the MEA I in this embodiment. Both electrodes 2 and 3 are within a central active area and the membrane extends beyond the ends of the first and second electrodes 2 and 3 into the perimeter area, where it is protected and sealed by an inner gasket 13. Thus, both the gasket 8 and the spacer 9 are interposed between the membrane 12 and the interconnect 4 in the perimeter area.

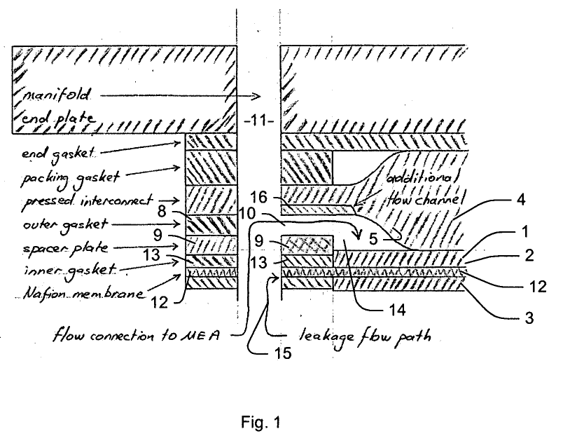

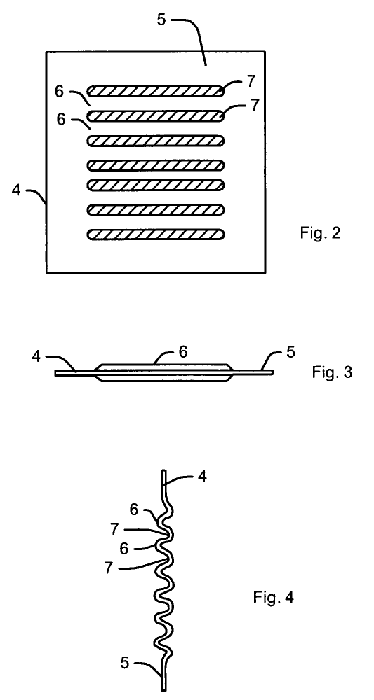

The key to the pressed bipolar plate is the symmetric design which keeps the whole plate co-planar outside the active area, whilst the ridges 6 and valleys 7 protrude equally on either side of the central plane within the active area. The general shape of this pressed plate is shown in FIGS. 2 to 4. Certain other geometries are possible for the ridges and valleys but this straight parallel design is simple and functional. It should be noted that one significant lack of symmetry occurs in the fact that one side has one more ridge than the other, 7 compared to 6 ridges, as identified in the figures. Compressive forces on the MEA should be balanced on either side, so the simple solution is to operate all cells in a stack with back-to-back plates. This results in an alternating series of odd-ridge and even-ridge cells. Since in general the cells will be part of a multi-cell stack, each cell must have an effective overall thickness that is the same from edge to edge, so that the design must build up the surrounding areas to match the thickness of the active area. This is achieved by an assembly of gaskets and stiff, incompressible spacers, including the gasket 8, the spacer 9, and the inner gasket 13. The selection of these gaskets and spacers is critical, as both perform additional roles related to the flow port 10. FIG. 1 is a cross-sectional view of the cell assembly which demonstrates the roles of the components, particularly in relation to flow paths.

Firstly, FIG. 1 shows how a header space 14 is created at either end of the ridges by the fact that the gaskets 8 and 13, and the spacer 9 are set back a distance from them. The ability to create a header space within a void in this way is critical to the ability of the design to function in a bipolar way. If a header channel were pressed into the plate as a full-depth valley feeding into a row of valleys, it would be manifest as a ridge creating a row of blind valleys on the other side, and is therefore unworkable in a bipolar design.

FIG. 1 is a horizontal cross section through a cell taken through the centreline of one of the manifolds and also shows the method used for fluid flow between the active area on one side of the cell and its associated manifold 11. The flow path is achieved by the slot cut through the gasket 8 (typically a similar width to the manifold diameter) to form the flow port 10. The spacer 9, in the form of a spacer plate, plays an important role in the success of this method since it restrains an inner gasket 13. If this gasket is not held firmly against the membrane 12, a flow path 15 (leakage flow path) to the wrong side of the cell exists on the other side of the membrane when a short length of it is not kept in compression from both sides. In fact all gaskets should be fully supported on both sides since they are not structural materials and may distort to allow leakage flow if they are not constrained against fluid pressure. The spacer material should be relatively stiff. A plastic material is unlikely to be successful. Titanium sheet is a suitable material and certain grades of stainless steel may also be suitably durable in this location of the cell and are cheaper and generally stiffer than titanium.

It should be recognized that this flow-path design does force some compromises in other areas of cell design. Specifically, the flow port 10 that is created is relatively narrow in one direction, only the thickness of the gasket 8. Electrolyser designs generally use recirculating water flows so that this port should be as large as practical in order to minimize the power requirements of the recirculating pump. The actual thickness of the gasket is determined by a number of other variables. It can be optimized by having a high ridge amplitude in the pressing and by minimizing the thickness of the inner gasket and the spacer plate. Other techniques include grinding a recess, in the form of an additional flow channel 16, into the pressed plate 4 to increase the overall thickness of the flow port. A gasket thickness of 0.3 to 0.4 mm has been used successfully. An additional technique to minimize flow resistance is to make the flow path as short as possible by locating the manifold very close to the edge of the active area.

Gasket materials may range from relatively pliable materials such as silicone rubber to harder materials such as polyethylene and Teflon. Harder materials may be more durable and more stable but place more exacting requirements on getting the correct gasket thickness for the cell to seal properly and to have the correct pressure against the electrodes in the active area.

An example of this invention employed a simply-manufactured titanium pressed plate to produce a single-cell electrolyser with an active area of 50 cm². The outer gasket was approximately 0.3 mm thick. This cell achieved a peak efficiency of 69% at a current density of 1 A/cm².

Another example of the use of this invention is a single-cell electrolyser with 50 cm² active area which has been constructed using pressed titanium plates. It also had an outer gasket that was approximately 0.3 mm thick. It has operated successfully at currents of 0.5 A/cm² and higher for a period of 3000 hours. It has run over this entire period sharing a common current with a cell made of similar components, except for the use of a machined titanium plate. The pressed plate cell has been demonstrated to have durability at least equivalent to the machined-plate cell with only a marginal loss in efficiency.

Another example of this invention has been the construction of a 4-cell stack using pressed titanium plates with an active area of 50 cm² per cell. This stack utilized pressed plates with a slightly lower amplitude but this was compensated for by the use of thin (0.1 mm) inner gaskets, so that the outer gasket remained approximately 0.3 mm thick. This stack achieved a peak overall efficiency of 70% with best cell in the stack achieving an individual efficiency of 74% at a current density of 1 A/cm².

Another example of this invention is a single-cell electrolyser with 50 cm² active area using pressed titanium plates, employing an additional sputtered metallic coating on both plates. The inner gasket was further reduced to 0.05 mm and the outer gasket was increased to 0.4 mm, allowing slightly larger water flows than previous examples. This cell achieved a peak efficiency of 79% at a current density of 1 A/cm².

Although the present invention has been described with particular reference to certain preferred embodiments thereof, variations and modifications of the present invention can be effected within the spirit and scope of the following claims.

We claim:

1. An electrochemical cell having a central active area and a perimeter area, the electrochemical cell including:
a membrane electrode assembly (MEA) having a first electrode, a proton exchange membrane, and a second electrode of opposite electrical polarity to the first electrode;
a pressed metal interconnect having on a first side a raised portion in electrical contact with the first electrode;
the interconnect and the first electrode defining at least one fluid channel between the interconnect and the first electrode in the central active area, such that a fluid conveyed in the fluid channel is in fluid communication with the first electrode;
a gasket interposed between the membrane and the interconnect in the perimeter area, such that the fluid is sealed within the fluid channel; and
a fluid opening in the gasket allowing fluid communication between the fluid channel and a manifold in the perimeter area.

2. An electrochemical cell as claimed in claim 1 including a spacer interposed between the membrane and the interconnect in the perimeter area adjacent the fluid opening to define a side of the fluid opening.

3. An electrochemical cell as claimed in claim 1 wherein the proton exchange membrane is a polymer electrolyte membrane interposed between the first and second electrodes.

4. An electrochemical cell as claimed in claim 3 wherein the first and second electrodes are within the central active area and the polymer electrolyte membrane extends beyond the ends of the first and second electrodes into the perimeter area.

5. An electrochemical cell as claimed in claim 1 wherein the raised portion includes a plurality of ridges in electrical contact with the first electrode, the ridges defining a plurality of the fluid channels between the interconnect and the first electrode.

6. An electrochemical cell as claimed in claim 5 wherein the ridges are located away from the gasket, thereby defining a header space in fluid communication with each fluid channel and the fluid opening.

7. An electrochemical cell as claimed in claim 1 wherein the interconnect includes on a second side opposing the first side, a second raised portion that can be in electrical contact with an electrode in a second electrochemical cell.

8. An electrochemical cell as claimed in claim 7 wherein the interconnect includes ridges on the first and second sides, each ridge forming a complementary groove in the opposing side, the ridges on the second side defining the second raised portion.

9. An electrochemical cell as claimed in claim 7 wherein the interconnect defines with each electrode in electrical contact, at least one respective fluid channel between the interconnect and the respective electrode, such that a respective fluid conveyed in each fluid channel is in fluid communication with the respective electrode.

10. An electrochemical cell as claimed in claim 7 wherein the interconnect is in electrical contact with electrodes of opposite electrical polarity, such that the interconnect is a bipolar interconnect.

11. An electrochemical cell as claimed in claim 1 wherein the interconnect includes in the first side a recess adjacent the fluid opening to increase the size of the fluid opening.

12. An electrochemical cell stack including a plurality of electrochemical cells in accordance with claim 7 connected in series, wherein the second raised portion of the interconnect of each electrochemical cell is in electrical contact with the second electrode of the next electrochemical cell.

13. An electrochemical cell stack including a plurality of electrochemical cells in accordance with claim 8 connected in series, wherein:
the ridges on the second side of the interconnect of each electrochemical cell is in electrical contact with the second electrode of the next electrochemical cell;
one of the first and second sides of each interconnect has one more ridge than the other of the first and second sides of the interconnect; and
successive interconnects have the first and second sides reversed, such that successive interconnects are in a back-to-back configuration.
